(19) United States
(12) Patent Application Publication
(10) Pub. No.: US 2022/0393882 A1
(43) Pub. Date: Dec. 8, 2022

(54) SECURED PRIVATE CREDENTIAL CERTIFICATE

(71) Applicant: Journey.ai, Denver, CO (US)

(72) Inventors: Shmuel Shaffer, Palo Alto, CA (US); Alexander John Shockley, Denver, CO (US)

(21) Appl. No.: 17/336,644

(22) Filed: Jun. 2, 2021

(51) Int. Cl. H04L 9/32; H04L 29/08; H04L 9/14

(52) U.S. Cl. CPC H04L 9/3263; H04L 67/1097; H04L 9/14

(57) ABSTRACT

The techniques herein are directed generally to a secured private credential certificate, such as for vaccination certificates. In one embodiment, a user presents their credential certificate(s) to a questioning enterprise, such that the questioning enterprise is only aware that the user presenting the certificate is the particular user that obtained the credential certificate from the credential authority, without determining an identity of the presenting user. Additionally, the questioning enterprise confirms whether the issuer of the certificate is valid, while not disclosing the identity of the questioning enterprise to the credential authority. In one embodiment, an intermediary storage server stores the credential certificate in a format unreadable to the storage server, and in a format unreadable to the questioning enterprise until the user provides a mechanism to convert the certificate into a format that is readable only to the questioning enterprise prior to the certificate being shared by the storage server.

### TECHNICAL FIELD

The present disclosure relates generally to information verification systems, and, more particularly, to a secured private credential certificate (e.g., a vaccination certificate).

### BACKGROUND

Proving credentials, such as who an individual actually is, how old the individual is, what the individual actually has, and so on, has been a concern throughout history, and greater requirements for privacy and security have evolved over time. For instance, driver's licenses did not originally include pictures, and then later included special emblems and bar codes to further reduce counterfeiting. Online identification, also, has been growing from simple usernames and passwords to biometric identification (e.g., facial recognition). The need for credentials continues to grow, both in terms of uses and in terms of verification.

For instance, with the recent onset of COVID-19, many restrictions have been enacted for social gatherings and travel. In certain circumstances, a complete prohibition is in place, while in other circumstances, only those individuals that have been vaccinated against COVID-19 (or tested) are allowed to enter a venue, travel, etc. However, knowing who has and who has not been vaccinated is currently based on simplistic paper documentation that is easily counterfeited.

For example, an individual may obtain a paper certificate upon testing or vaccinating, whether from the test/vaccination facility or from a government appointed agency. Then, in order to gain access to a particular establishment or to pass travel checkpoints, the individual would then need to present this paper certificate for inspection. To be effective, the individual should also be required to present a picture identification (ID) to ensure that the paper certificate is, in fact, being presented by the valid owner (i.e., that the picture ID matches the name on the paper certificate).

There are many deficiencies with the use of paper certificates, however. In addition to the ease at which invalid counterfeit certificates could be generated or where errors in (or complete lack of) matching the certificate to picture IDs are prevalent, privacy concerns are also paramount whenever an identification is required to enter any given establishment (e.g., having to provide a full name for everyone in a party visiting a bar/restaurant) or to travel. Moreover, the inspector of the paper certificates (who notably costs money to employ) must be aware of the latest rules and regulations, which are ever-changing, and the paper certificates themselves may become quickly outdated as new guidelines are released. In addition, the number of documents required may increase based on regulations, such as requiring both proof of vaccination and proof of a recent negative test result, and ensuring that an individual has a copy of their certificate(s) at all times can cause many issues of inconvenience.

### SUMMARY

The techniques herein are directed generally to a secured private credential certificate, such as, in one particular embodiment, for vaccination certificates. In particular, based on an advanced “zero-knowledge architecture”, the techniques herein allow for the secure management of user identity (e.g., full name or more, including birthday, driver's license numbers, and other PII) and credential status (e.g., vaccinations, tests, age minimums, and so on) via frictionless communication. Specifically, the techniques herein allow a user, with their mobile device, to present their credential certificate(s) (issued by a credential authority) to a questioning enterprise (e.g., a restaurant, an airline, etc.), in such a manner that the questioning enterprise is only aware that the user presenting the certificate from their device is the particular user that obtained the credential certificate from the credential authority, without determining an identity of the presenting user (or of the user associated with the credential certificate, if different). Additionally, the techniques herein allow the questioning enterprise to confirm that the issuer of the certificate is valid, while also not disclosing the identity of the questioning enterprise to the credential authority. In one embodiment, as described herein, this is facilitated through the use of an intermediary storage server (of the zero-knowledge architecture) that stores the credential certificate in a format unreadable to the storage server, and in a format unreadable to the questioning enterprise until the user (user's device) provides a mechanism to convert the certificate into a format that is readable only to the questioning enterprise prior to the storage server sharing the certificate to the questioning enterprise.

In one specific embodiment, an illustrative method according to one or more embodiments of the present disclosure may comprise: receiving, at a user device, a signed credential certificate from a credential authority, the signed credential certificate certifying one or more credentials associated with a user of the user device; storing, by the user device, the signed credential certificate on a storage server in a format that no device other than the user device is able to read the signed credential certificate; establishing, by the user device, a communication with a questioning device inquiring about the one or more credentials associated with the user; establishing, by the user device, a conversion key for the questioning device; and sending, from the user device, the conversion key to the storage server, causing the storage server to i) convert, based on the conversion key, the signed credential certificate into a format readable only by the questioning device; and ii) send the signed credential certificate in the format readable only by the questioning device to the questioning device.

In another specific embodiment, an illustrative method according to one or more embodiments of the present disclosure may comprise: establishing, by a questioning device, a communication with a user device, wherein the questioning device is inquiring into one or more credentials associated with a user of the user device; providing, by the questioning device, information to cause the user device to establish a conversion key for the questioning device; receiving, at the questioning device, a signed credential certificate established by a credential authority, the signed credential certificate certifying one or more credentials associated with a user of the user device, the signed credential certificate being encrypted based on the conversion key for the questioning device being used to convert the signed credential certificate from a format that no device other than the user device is able to read into a format readable only by the questioning device; and decrypting, by the questioning device, the signed credential certificate in the format readable only by the questioning device to obtain the signed credential certificate.

Other embodiments of the present disclosure may be discussed in the detailed description below, and the summary above is not meant to be limiting to the scope of the invention herein.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example simplified computer network;

FIG. 2 illustrates an example of a computing device;

FIG. 3 illustrates an example of verified communication between two endpoints according to one or more embodiments herein;

FIG. 4 illustrates an example of a “zero-knowledge enablement network” framework according to one or more embodiments herein;

FIG. 5 illustrates an example basic architecture and example flow for user onboarding according to one or more embodiments herein;

FIG. 6 illustrates one example of a secured private credential certificate exchange according to one or more embodiments herein;

FIG. 7 illustrates another example of a secured private credential certificate exchange using government certification according to one or more embodiments herein;

FIG. 8 illustrates another example simplified procedure for managing a secured private credential certificate in accordance with one or more embodiments described herein, particularly from the perspective of a user device presenting their user's certificate;

FIG. 9 illustrates an example simplified procedure for managing a secured private credential certificate in accordance with one or more embodiments described herein, particularly from the perspective of an entity questioning the certificate; and

FIG. 10 illustrates another example simplified procedure for managing a secured private credential certificate in accordance with one or more embodiments described herein.

### DESCRIPTION OF EXAMPLE EMBODIMENTS

A computer network is a distributed collection of nodes (e.g., transmitters, receivers, transceivers, etc.) interconnected by communication links and segments for transporting signals or data between the nodes, such as personal computers, workstations, mobile devices, servers, routers, or other devices. Many types of computer networks are available, including, but not limited to, local area networks (LANs), wide area networks (WANs), cellular networks, broadband networks, infrastructure or backhaul networks, public switched telephone networks (PSTNs), and many others.

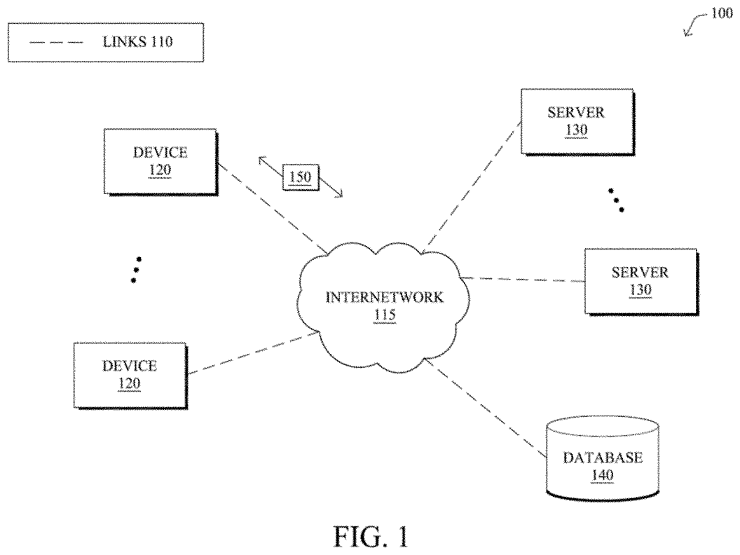

FIG. 1 illustrates an example, and simplified, computer network 100. As shown, computer network 100 may contain various devices communicating over links 110 and an internetwork 115, which provides communication paths to end devices 120, servers 130, databases 140 (which may be part of servers 130 or in communication with and under the control of servers 130), and other devices as will be appreciated by those skilled in the art. Data transmissions 150 (e.g., packets, frames, messages, transmission signals, etc.) may be exchanged among the nodes/devices of the computer network 100 using predefined communication protocols where appropriate over links 110. In this context, a protocol consists of a set of rules defining how the nodes interact and exchange information with each other.

Notably, the computer network 100 may comprise various individual networks intercommunicating with each other, such as LANs, WANs, cellular/LTE networks, PSTN, and so on, and may include any number of wired or wireless links between the devices, accordingly. Note also that while links 110 are shown generically interconnecting with the internetwork 115, any number of intermediate devices (e.g., routers, switches, firewalls, etc.) may actually make up the composition of the network 100 and internetwork 115, and the view shown herein is merely a simplified illustration.

End devices 120 may comprise different types of devices, such as, e.g., personal computers, desktop computers, laptop computers, mobile devices, tablets, smartphones, wearable electronic devices (e.g., smart watches), smart televisions, set-top devices for televisions, workstations, smart vehicles, terminals, kiosks, automated teller machines (ATMs), point of sale (POS) devices, applications running on such devices, and so on, often interfacing with human users, though not necessarily. For instance, end devices 120 may also comprise drones, automated vehicles, artificial intelligence “beings” or robots, internet of things (IoT) devices, and so on.

Servers 130 and/or databases 140 may comprise singular servers and/or databases, server and/or database farms, cloud-based server and/or database services, network attached storage (SAN), and any other type or configuration of computing devices that provides computing and/or storage services as will be appreciated by those skilled in the art. Servers 130 and/or databases 140 may be centralized (i.e., processing and/or storage occurring on a single device or within a single location of devices) or distributed/decentralized (i.e., processing and/or storage occurring across multiple devices or across a plurality of locations). Notably, for example, servers 130 and/or databases 140 may be deployed on the premises of an enterprise or may be cloud-based.

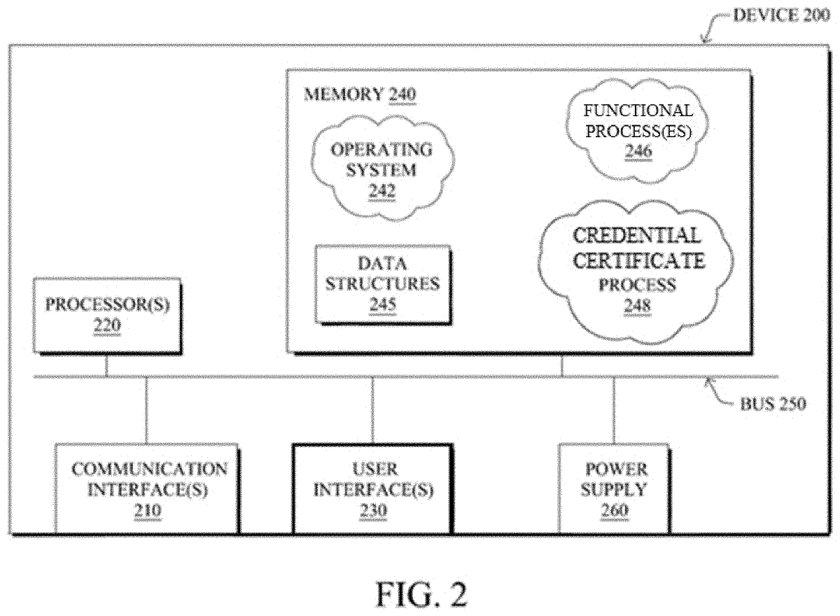

FIG. 2 is a simplified schematic block diagram of an example computing device 200 that may be used with one or more embodiments described herein (e.g., end device 120, sever 130, database 140, etc.). Illustratively, device 200 may generally include one or more communication interfaces 210, one or more processors 220, and a memory 240 interconnected by a system bus 250 or other dedicated circuitry, and is powered by a power supply system 260. Additionally, the device 200, where required, may comprise one or more user interfaces 230 configured to solicit and receive user input (input/output or “I/O” components, such as displays, keyboards, cameras, touchscreens, biometrics, and so on).

The communication interfaces 210 include the mechanical, electrical, and signaling circuitry for communicating data over wired and/or wireless links of a communication network.

The memory 240 includes a plurality of storage locations that are addressable by the processor(s) 220 for storing software programs and data structures associated with the embodiments described herein. The processor(s) 220 may comprise necessary elements or logic adapted to execute the software programs and manipulate the data structures 245. An operating system 242, portions of which are typically resident in memory 240 and executed by the processor(s) 220, functionally organizes the device by, among other things, invoking operations in support of software processors and/or services executing on the device. Illustratively, these software processes and/or services may include one or more functional processes 246 (e.g., specific to functionality of the device), and an example “credential certificate” process 248 that is configured to perform the operations described herein, particularly in conjunction with other devices having similar functional processes.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

——Secure Identity Verification ——

One major problem faced today is verification of users at the ends of various communications. For example, a company often wants to confirm that they are communicating with an intended customer, while a customer often wants to confirm that they are communicating with the intended company. The same could be true for any two users or end-points at either end of a communication, as well as when two users are located at the same physical location and when the identity of an individual needs to be confirmed, as described herein. For example, as described below, it may be necessary to ensure that a person presenting documentation (e.g., a license, certificate, etc.) is actually the person to whom the documentation was issued. At the same time, as also described below, privacy concerns often exist where it is desired to prevent disclosure of the identity of this person while presenting the documentation, such as where it must only be ensured that the specific “un-named individual” is the rightful owner of the documentation.

Moreover, information privacy and security are also particularly important to consumers and computer technology. With the proliferation of hacking incidents against user information, attack vulnerability has been addressed in many ways to prevent or at least detect unsanctioned access to data and user information. Still, to this day, such efforts have been unable to keep up with the dedication of ill-willed individuals to overcome the many layers of security, the authorized access management, and the overall ever-changing data security landscape set forth by the administrators tasked with protecting the stored and communicated data. Additionally, customers and businesses want to know that their information is secure, whether from hackers breaking into contact center databases, or from unscrupulous people with visibility or access to displayed information, who may be stealing or merely sharing personal information, including full names, visited locations, credential status, and so on.

Accordingly, to address the needs of today's sophisticated users and companies, the techniques herein are directed to frictionless user experience and stringent security to prevent improper use or abuse of private information, including whereabouts and credential information, without sacrificing the security of the information or ease of use. That is, the techniques herein first address the verification of the identity of any entity at the end of a communication (i.e., an identity of an end user, such as a patron, traveler, temporary shift worker, patient, and so on).

Notably, this disclosure may utilize various aspects of the system described in U.S. patent application Ser. No. 16/861,715, entitled “Providing access control and identity verification for communications between initiating and receiving devices”, filed on Apr. 29, 2020 by Shaffer et al., now published as U.S. Patent Application Publication No. 2020/0259830 on Aug. 13, 2020, the contents of which being incorporated herein by reference in its entirety.

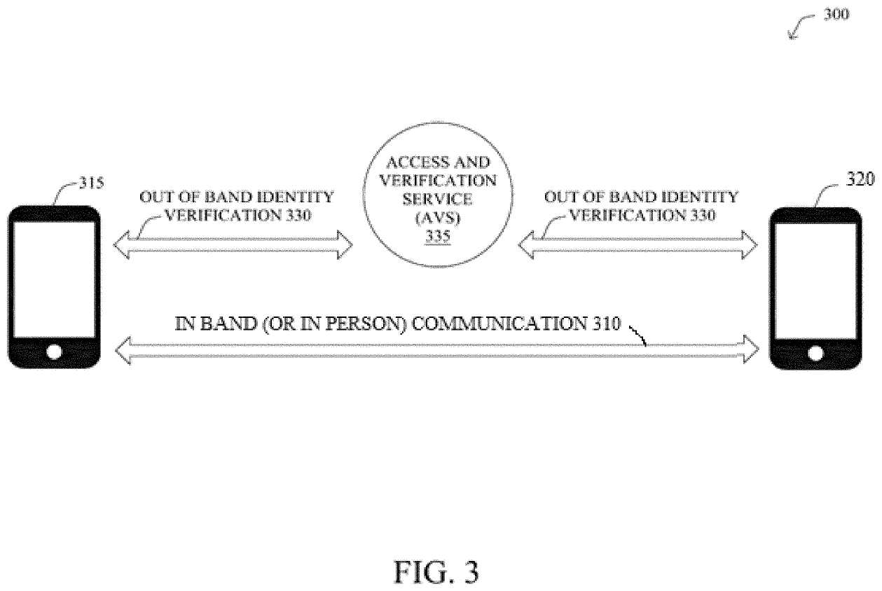

With reference to the high-level view in FIG. 3, a verified communication 300 begins with a communication 310 (voice call, text, video call, data session, etc., including in-person visual communication, such as a camera of one device accepting an image, such as a QR code, from another device) between two endpoints (over a “communication channel”), illustratively user devices 315 and 320, though also servers, automated kiosks, etc., such as described herein. Through services offered by the techniques herein, referred to generally as “access and verification services” (AVS) (as well as the corresponding AVS application/clients/servers that are configured to participate in such services, as described herein, such as AVS server 335 as shown in FIG. 3), a digital identity verification service may utilize “out of band” data network signaling 330 (over a “verification channel”) to ensure the communicating parties (notably in either direction) are who they say they are. Note that as used herein, the “out of band” verification channel implies that the verification occurs outside of the logical or physical communication channel. In other words, where the “communication channel” is whichever transmission medium is providing the communication between the two end devices (e.g., over PSTN, the Internet, etc.), the “verification channel” may be a separate data communication channel (e.g., still possibly over the Internet or other secure transmission network) that provides the verification of identities as described herein (e.g., communications between the end devices and the corresponding AVS application/clients/servers that are configured to facilitate identity verification). Note that in certain example embodiments, the verification channel and communication channel may traverse through the same paths (e.g., both over the internet, but still separate in that the verification does not occur vocally over the voice call or other communication medium, such that the verifier need not hear/see any authentication factors of the entity to be verified).

It should be noted that for the sake of simplicity FIG. 3 shows the communication between the two user devices to communicate in-band and the user device communication with the server over an out-of-band communication link. It should be apparent to those skilled in the art that any communication between two entities can take place either in-band or out-of-band.

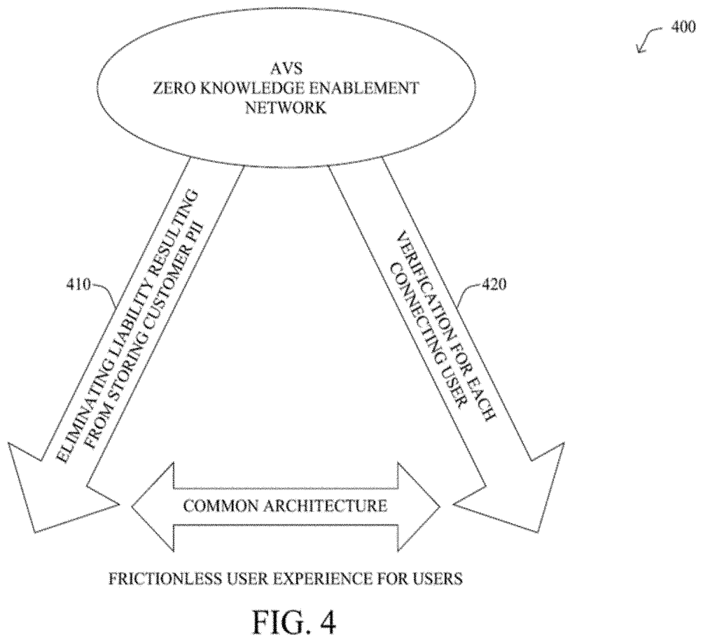

FIG. 4 illustrates an example of a “zero-knowledge enablement network” framework 400 that may be used for the system described herein (e.g., the AVS server 335). Notably, the left “leg” 410 of the framework is technology that eliminates liability resulting from storing customer personally identifying information (PII). Such a “zero-knowledge” data management network allows users to share verifiable proof of data and/or a limitless list of details about themselves (identify information), and businesses are able to request, consume, and act on the data, providing a hyper-personalized experience—all without a data storage server or those businesses ever seeing or having access to the raw sensitive information. That is, the embodiments herein may utilize a decentralized network for trust, identity, privacy, and personalization that reinvents secure data storage and digital identities, where server-stored data is viewable only by intended recipients (which may even be selected after storage of the data). Perhaps more importantly, the techniques herein allow for devices without access to the data to trust the contents of the data (e.g., without even being able to decrypt and access/read the data), guaranteeing that a user's identity is what he/she claims it to be. That is, the zero-knowledge data management system herein can strategically employ the use of an attestation service (e.g., an identity verification service) or other identity verification service (e.g., biometrics such as facial recognition, iris recognition, fingerprinting, voice recognition, etc.), with controlled and limited access to the data (i.e., if desired, no access to the data itself, but instead only access to the fact that the data (to which one does not have access) is verified to be correct).

The “right leg” 420 of the framework in FIG. 4 addresses verification for each user at either end of a communication (e.g., on one end, a patron, traveler, etc., and on the other end, a verifier, authenticator, security personnel, a remote server, etc.), such as users or devices communicating over long distances (e.g., over the internet) or users/devices in close proximity to one another (e.g., using cameras and QR codes, using verifying pin codes, etc.). For instance, using an attestation service or other identify verification service through a common architecture (or through a secure interface), the techniques herein may establish a frictionless user experience for users that is above and beyond typical multi-factor authentication, in terms of security (ensuring identity), privacy (protecting identity), and frictionless user experience (ease of functionality).

As described in greater detail below, the zero-knowledge data management system herein can also verify that a particular user, with an attested identity, has particular certified credentials, accordingly, all without requiring exposure of the actual identity of the particular user, and optionally without exposure of the details of the credentials.

(Notably, the framework shown in FIG. 4 is merely one example implementation, which is based on extending the services of a common architecture used for the confidential storage of PII and for the user's verification. Other implementations and architectures may be used herein that do not require all of the components described herein, or that use additional components not described herein, and the illustrative examples shown and described herein are not meant to be limiting to the scope of the present disclosure.)

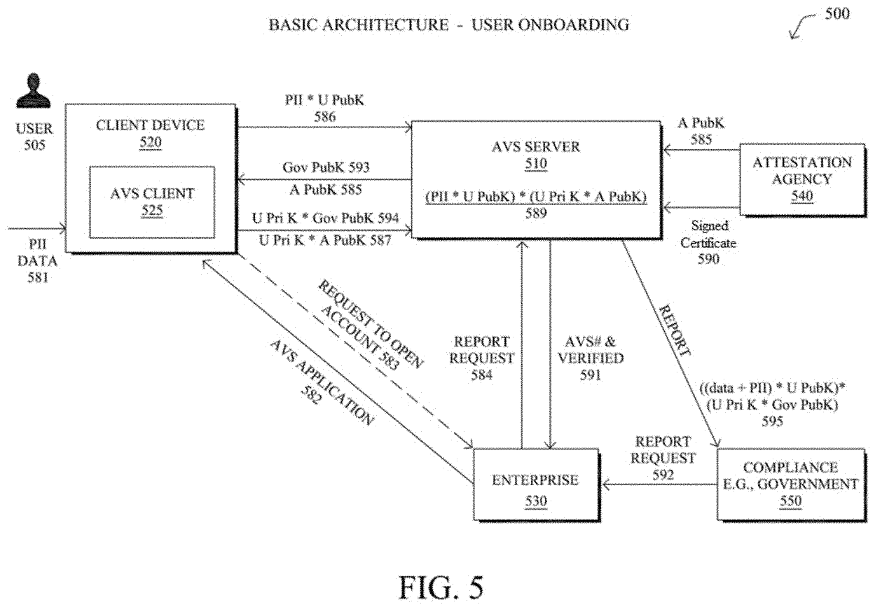

FIG. 5 illustrates an example basic architecture 500 and example message/information flow for user onboarding to an illustrative computing environment herein. For instance, the illustrative primary components of the architecture are the “AVS server” 510 (implementing or at least coordinating/facilitating the techniques herein), a client device 520 operating an “AVS client” or application/app 525, and an enterprise 530 (described herein). Additionally, an attestation agency 540 may be used to attest to (verify) the identity of the user 505. In certain embodiments, a compliance service 550 (e.g., the government) may also be connected to the AVS server and the enterprise in order to request and receive reports about the users, as will be understood by those skilled in the art. Note that for certain embodiments herein, the communications between the devices in FIG. 5 may be securely managed (transmitted and stored) in accordance with a zero-knowledge data management network as mentioned above. That is, the architecture 500 of FIG. 5 may be used in conjunction with the zero-knowledge data management technique described in FIG. 4 above, serving as a foundation for a infrastructure of both the zero-knowledge data management system and the access control and identity verification system described herein.

As a reminder, traditional asymmetric encryption schemes (also referred to as asymmetric-key or public-key) are cryptographic systems that use pairs of keys, where the intended recipient's encryption key is published (e.g., disseminated widely or else obtained as-needed) for anyone to use and encrypt data and messages. However, only the receiver has access to a corresponding decryption key that enables data and messages to be read. As an example, for ease of discussion, asymmetric encryption is much like multiplication in terms of its commutative and associative properties, meaning that the order of applying an encryption or decryption key to the data (an “encrypting combination” generally, herein) does not matter. This may be represented mathematically as:

A=(B*C)*D=C*(B*D)=(C*D)*B,etc. Eq. 1,

where “*”—denotes the encryption/decryption operator.
Traditional asymmetric encryption may thus be represented generally as follows (where the encryption, decryption, or generally “encrypting combination” where keys are applied to raw or encrypted data, is represented in the equation as a multiplication or “*”):

Raw Data*Public Key=>Cypher Data Eq. 2a;

As mentioned, to decrypt data encrypted by a public key, a private key is used, since:

Public Key*Private Key=>1(decryption) Eq. 2b.

Therefore, the decryption of the cypher data would be represented as follows:

Cypher Data*Private Key=(Raw Data*Public Key)*Private Key=Raw Data*(Public Key*Private Key)=Raw Data*(1)=>Raw Data Eq. 2c.

Unlike traditional encryption, however, where the source device would normally encrypt the data with recipient encryption keys (e.g., public keys), the above-referenced U.S. Patent Application Publication No. 2020/0259830 provides a technique in which a source device's use of its own encryption key (e.g., its public key, herein) ensures that only the source device can decrypt the source-encrypted source data with its decryption key (e.g., its private key, herein). For instance, when a source device has data to encrypt (e.g., PII 581 in FIG. 5 above), this source data may be encrypted with a source encryption key (e.g., a public key, hereinafter “PubK”) of the source device to form source-encrypted source data (“Src-Encrypt Src Data”) as shown below:

Src Data*Src PubK=>Src-Encrypt Src Data Eq. 3.

That is, no other device, including the storage server 510 (or recipient devices 530 or otherwise), can decrypt the source-encrypted source data. Note that in the traditional sense, a device's decryption key is its private key, so only it, as a receiver, can decrypt encrypted data. However, as used herein in the preferred embodiment, since the source device has changed the role of its keys, the use of the term “encryption key” corresponds to the key used by the source device herein to encrypt the source-encrypted source data (e.g., the public key), while “decryption key” corresponds herein to the paired key used by the source device to decrypt or, as described below, re-encrypt the source-encrypted source data. (Note also that in this sense, any device with access/knowledge of the source device's public/encryption key can generate source-encrypted source data, though only the source device itself would then have control over the decryption of that source-encrypted source data, as described herein. This may be useful, for instance, in certain embodiments where another trusted device generates and stores data on behalf of the source device, and the source device controls further access to this data, accordingly.)

As also described in the above-referenced U.S. Patent Application Publication No. 2020/0259830, the source device (e.g., client device 520) can also control the decryption, specifically, who can decrypt the source data, such as through re-encryption techniques. For instance, after the encryption takes place, the source device may send the source-encrypted source data to a storage server (e.g., 510), which even though the storage server obtains and stores the source-encrypted source data, it is completely unable to decrypt it (that is, without having the source device's private/decryption key). Note also that the source device need not continue to store the raw data, and may delete (or generally not store) any source data once it is encrypted into the source-encrypted source data for even further security against hacking (e.g., locally decrypting it if needed again in the future using its own decryption key, whether for access or editing).

According to the illustrative re-encryption techniques, the source device also establishes a “recipient-based rekeying key” (or “conversion key”, generally) through an encrypting combination of a source decryption key (e.g., private key) of the source device and a recipient public key of a particular recipient device (e.g., an enterprise 530). In particular, the source device uses its decryption (e.g., private) key (“Src PriK”) to encrypt the recipient public key (“Rcpt PubK”) (though as mentioned above, the same result would essentially occur by encrypting the Src PriK with the Rcpt PubK), and creates the recipient-based rekeying key (“Rcpt-B sd Rekey Key”), accordingly:

Src PriK*Rcpt PubK=>Rcpt-Bsd Rekey Key Eq. 4a.

Notably, in one embodiment, the source device receives the recipient public key by receiving it from the recipient device, such as from public distribution of public keys or requesting certain keys for participating recipient devices (e.g., governments, retail establishments, reward programs, financial institutions, social networks, etc.). In addition to the recipient devices informing the source device of their recipient public key, techniques herein also specifically contemplate the scenario where the public key of a particular recipient is obtained in response to a request to share the source data with the particular recipient (as described below). For example, a controller device or a particular recipient device may send a request to the storage server requesting that the source data be sent to the particular recipient device. At this time, therefore (i.e., where the request is received prior to obtaining the recipient-based rekeying key), the storage server may obtain, if not already stored, the public key of the particular recipient, and shares it with the source device, to thus cause the source device to establish and send the recipient-based rekeying key (conversion key) to the storage server.

The source device then sends the recipient-based rekeying key to the storage server (e.g., AVS server 510), which, notably, still does not allow the storage server to decrypt the source-encrypted source data. That is, the rekeying key is only useful by the storage server to re-encrypt the source-encrypted source data in a way that allows the particular recipient device, correspond to that recipient-based rekeying key, to decrypt the data, as described below. Additionally, since the recipient-based rekeying key is a combination of the source device's private key (or other decryption key) and the recipient device's public key, the only data transformation that the storage server (e.g., if hacked), or any other device for that matter, could perform on the recipient-based rekeying key is based on knowing the source device's public key, which as shown in Eq. 4b below, merely would result in the publicly known public key of the recipient:

Rcpt-Bsd Rekey Key*Src PubK=(Src PriK*Rcpt PubK)*Src PubK=(Src PriK*Src PubK)*Rcpt PubK=(1)*Rcpt PubK=>Rcpt PubK Eq. 4b.

The source device may send the recipient-based rekeying key to the storage server after sending the source-encrypted source data, such as when the source data is sent at the direction of the source device, and then requests later dictate the creation of particular rekeying keys. On the other hand, the source device may also send the recipient-based rekeying key to the storage server contemporaneously with sending the source-encrypted source data, such as where the source device dictates the sharing of the data with particular recipients, or else where the data is collected in response to the request to share the data with the recipient or in anticipation of receiving a request to share the data, such as anticipating a request from the government to share the data, or in anticipation of a request from a bank to share specific information with the government (e.g., 550).

Whenever the storage server (e.g., AVS server 510) receives a request to share the source data with a particular recipient device (e.g., enterprise 530), regardless of where the request originates, the storage server may request the recipient-based rekeying key if it doesn't already have it (and may share, or facilitate sharing, the recipient device's public key if the source device doesn't already have that, too). Once the storage server has the recipient-based rekeying key from the source device (which, notably, may have been received contemporaneously with the request or prior to obtaining the request), and also the source-encrypted source data from the source device (which, notably, may have been received contemporaneously with the rekeying key, thus also possibly contemporaneously with the request or prior to obtaining the request), the storage server 510 may then re-encrypt the source-encrypted source data with the recipient-based rekeying key, accordingly. In particular, the re-encrypting results in the source data being encrypted with the recipient public key of the particular recipient device, i.e., “recipient-based encrypted source data” (“Rcpt-B sd Encrypt Src Data”), as shown below in Eq. 5:

Src-Encrypt Src Data*Rcpt-Bsd Rekey Key=(Src Data*Src PubK)*(Src PriK*Rcpt PubK)=Src Data*(Src PubK*Src PriK)*Rcpt PubK=Src Data*(1)*Rcpt PubK=Src Data*Rcpt PubK=>Rcpt-Bsd Encrypt Src Data Eq. 5.

Note that the storage server 510 is still unable to decrypt the source data encrypted with the recipient public key (i.e., recipient-based encrypted source data), since only the particular recipient device can do that with its private key (described below). No other device, including the controller device, other recipient devices, or, in fact, the source device, can decrypt the recipient-based encrypted source data, so even if a hacker somehow obtained the recipient-based encrypted source data, they would have no way to open/access the raw source data, or any other useful information.

At the direction of the request (or based on any other triggers), the storage server may now send the recipient-based encrypted source data to the particular recipient device. Upon receipt, this causes or otherwise enables the particular recipient device to decrypt the recipient-based encrypted source data using a recipient private key of the particular recipient device to thereby obtain the original/raw source data. This is shown below:

Rcpt-Bsd Encrypt Src Data*Rcpt PriK=(Src Data*Rcpt PubK)*Rcpt PriK=Src Data*(Rcpt PubK*Rcpt PriK)=Src Data*(1)=>Src Data Eq. 6.

Accordingly, the particular recipient device may then process the decrypted source data in any way so configured/desired. Notably, “causing the particular recipient device to decrypt” as used herein may generally imply that the recipient device, which now has the encrypted data and the private key to decrypt it, is enabled to decrypt the data as needed/desired—for instance, the recipient-based encrypted source data may simply be stored at the recipient device until one or more internal triggers at the recipient device actually result in the decryption (e.g., a particular government agent becoming available to investigate a transaction).

Further details of re-encryption techniques may be found in U.S. Patent Application Publication No. 2020/0259830, including adding attestation of the information, signing attested information, and compliance (e.g., government) access to the information.

In particular, and returning again to FIG. 5, according to one specific embodiment of user onboarding and authentication (e.g., initial verification of a new user), a third-party (e.g., the AVS server) can obtain attestation from an attestation service (i.e., that the user is who they say they are) by: storing PII information on a third-party server, wherein the third-party server and an attestation service cannot read the stored information; storing, on the third-party server, a re-encryption key that converts the stored information to a format readable to only the attestation service; requesting, by the third-party server from the attestation service, attestation of whether the stored information is correct, wherein requesting comprises applying the re-encryption key to the stored information and sending the stored information, in the format readable to only the attestation service, to the attestation service; receiving, by the third-party server from the attestation service, an indication as to whether the stored information, which cannot be read by the third-party server, is attested as correct by the attestation service; and providing, from the third-party server, the indication as to whether the stored PII information is attested as correct by the attestation service to an interested device (e.g., an enterprise), without the third-party server knowing the information.

Specifically, this type of “zero-knowledge attestation” according to one or more specific embodiments herein, begins with attestation agency/server being configured as a verification service that comprises one or both of automated attestation or manually assisted attestation techniques, as generally understood by those skilled in the art. For example, a typical identity verification service, in particular, ensures that users or customers provide information that is associated with the identity of a real person, such as by verifying the authenticity of physical identity documents such as a driver's license or passport (“documentary verification”), and/or by verify identity information against authoritative sources such as a credit bureau or government data (“non-documentary verification”). Manually-assisted techniques, which may be performed also through artificial intelligence, may include identity verification through webcams (e.g., holding up a driver's license next to a user's face to confirm the visual comparison and the data on the license). Identity “scoring” (e.g., likelihood that a user is who they say they are) may also be used and shared as a result, e.g., rather than (or in addition to) a simple yes/no or verified/not result. To attest to data integrity, on the other hand, various methods of trusted computing and remote attestation may be used, allowing a program at the source device to authenticate itself (e.g., the software/version running at the source device) or the data (e.g., computed hashes, configuration data, revision tracking, and other data/meta-data-based information). Completeness of the records/data may also be attested to, such as confirmations that all requested data fields have been filled in with legitimate answers, even if the accuracy of the answers themselves are not specifically attested to in certain configurations. Note that many different techniques may be used for identity and data integrity attestation, and that the specific techniques shown herein are merely examples for a better understanding of the role and responsibilities of attestation server/agency.

With reference still to FIG. 5, a communication exchange between the devices of the attestation service environment is based on an attestation request from the AVS server. Generally, any device within the system in FIG. 5 can initiate the attestation request, such as the AVS/storage server, the client device, or an enterprise as a verifying recipient device which may receive a signed certificate, a confirmation message, etc., without ever seeing the actual information/PII used for attestation.

As an example, a user 505 may enter his/her identity information as “source data” (PII data) 581 at the source device 520 (e.g., through the AVS app/client 525, which may be downloaded/obtained (582, as shown) from the enterprise 530 (e.g., branded), or from the AVS Server 510 (e.g., general)). The source device may then open or confirm an account (e.g., a credential certificate account, as described below) through request 583. In certain embodiments, the source data may be kept in secret, and as such, the source device or the controller device (enterprise 530) may inform the storage server 510 that a new user is trying to establish/confirm an account (report 584), and that an attestation to the identity of the user is needed (i.e., the source/PII data), thus “report 584” is also an “attestation request 584”. Notably, collection of the source data may be generalized (e.g., the source device collects the data to share generally with other devices as requested), or else the collection may be specifically directed by other devices, such as the attestation server, the controller device, or any other verifying recipient device. That is, the source device may receive instructions from any of these devices to collect the source data, either generally or in response specifically to an attestation request.

In this embodiment, the attestation server 540 shares its public key (“A PubK”) 585, either to the source device 520 directly or else to the storage server 510 which can then share it with the source device. Alternatively, the attestation server public key may be shared with the source device by any other method, including by being publicly known. Note that the source device may already have the attestation server's public key prior to the attestation request, or else may receive it in response to the attestation request (e.g., the storage server connects with the attestation server and obtains the attestation server's public encryption key, to then share it with the source device).

At this point, in this specific embodiment, the storage server (AVS server) 510 may either already have the source-encrypted source data (PII encrypted by the user's public key, “U PubK”) 586, or else the source device may encrypt the source data and provide the storage server with the source-encrypted source data 586. Here, the source device 520, in response to the attestation request (and in certain embodiments, thus receiving the attestation public key) establishes an attestation-server-based rekeying key 587 through an encrypting combination of the source decryption key (e.g., a private key, “U PriK”) of the source device and the attestation server public key (A PubK). Accordingly, by sending the attestation-server-based rekeying key 587 to the storage server 510, and in response to the attestation request 584 received at the storage server (i.e., a request to share the source/PII data with the attestation server), the AVS/storage server re-encrypts (e.g., is caused to re-encrypt) the source-encrypted source data 586 with the attestation-server-based rekeying key 587, where the re-encrypting results in the source/PII data being encrypted with the attestation server public key (attestation-server-based encrypted source data 589). Note still that the AVS/storage server is unable to decrypt the source data encrypted with the attestation server public key (i.e., attestation-server-based encrypted source data 589).

The AVS/storage server 510 may then send the attestation-server-based encrypted source data 589 to the attestation server 540 in response to the attestation request (for sake of simplicity not shown in the figure). Notably, the specific attestation request for source data may be associated with a trackable identifier (ID) in order to coordinate the attestation to the source data (e.g., a hash function of the data). That is, the ID pairs the request (and also a signed certificate, described below) with the source data (and thus source-encrypted source data).

Once the attestation server 540 receives the source data encrypted with the attestation server public key (attestation-server-based encrypted source data 589) from the storage server 510, then the attestation server applies its own private key to obtain and process the user's identity information from the previously encrypted source data (i.e., decrypting the attestation-server-based encrypted source data using an attestation server private key of the attestation server).

The attestation server may now view, verify, and attest to the decrypted source data (e.g., to the personally identifying information (PII), or else to the data integrity in other examples mentioned herein), using various attestation techniques. For example, PII may be attested to based solely on the source data (e.g., documentary verification) or else on greater information (e.g., non-documentary verification). For example, a communication may be established between the source device and the attestation server (not shown for sake of simplicity), where the attestation server is configured to attest to the PII based on the source data and user interaction via the established communication (e.g., webcam verification, real-time question answering, etc.). Any suitable attestation technique may be used herein, and those mentioned above are merely example embodiments for illustration.

Assuming the data is verified by the attestation server 540 (e.g., manually, autonomously, and/or autonomously with manual assistance), then the attestation server creates a signed certificate 590 signifying (acknowledging) the attestation to the source data (or non-attestation). The attestation contents of the certificate may be anything from a simple “verified” indication, an attestation score, a report of what is being attested to (e.g., “this certifies that user ID #12345 has acceptably provided their identity on this date”), and so on. In particular, according to the techniques herein, the attestation server creates a signed certificate (based on attesting to the source data) that would allow a verifying recipient device to confirm that the source data has been attested to by the attestation server based only on the signed certificate (i.e., without accessing/decrypting the source-encrypted source data). In one embodiment, the verification may be associated with a particular identification number tying it to the original request (e.g., an “AVS # & Verified” message 591), either by the attestation server 540 or appended by the AVS server 510.

In one embodiment, similar to digital signature techniques, the attestation server 540 signs its verification message (signing the signed certificate) 590 by encrypting the verification message (attestation contents) by its own private key (attestation server private key). This message can then be decrypted by any verifying recipient device (e.g., the enterprise 530) with knowledge of public key of the attestation server (which is known to everyone as it is public). Said differently, the verifying recipient device is caused to confirm that the source data and/or the source of the data has been attested to by the attestation server based on applying the attestation server public key to the signed certificate. Since the public key of the attestation server decrypts the message, it is proof that only the attestation server (the only entity that knows the attestation server's private key) could have written and signed this verification message.

Notably, as shown in FIG. 5, similar zero-knowledge storage and reporting of the PII information may also be performed by the AVS server for sharing reports with the compliance device 550, e.g., sharing PII information with the government for flagged transactions. For instance, the compliance device 550 may send a report request 592 to an enterprise 530 (e.g., a compliance report) in response to any number of triggers. Since the client device 520 also has obtained the compliance device's public key (“Gov PubK”) 593, it can then also create a compliance-device-based rekeying key 594 through an encrypting combination of the source decryption key (e.g., private key, U PriK) of the source device and the compliance device public key (Gov PubK). Accordingly, by sending the compliance-device-based rekeying key 594 to the storage server 510, and in response to the report request 592, the storage server re-encrypts (e.g., is caused to re-encrypt) the source-encrypted source data 586 (and optionally other report-related data) with the compliance-device-based rekeying key 594, where the re-encrypting results in the source/PII data being encrypted with the compliance device public key (compliance-device-based encrypted source data 595). Note still that the storage server is unable to decrypt the source data encrypted with the compliance device public key (i.e., compliance-device-based encrypted source data 595). The storage server 510 may then send the compliance-device-based encrypted source data 595 to the compliance device 550, which can then apply its own private key (“Gov PriK”) to obtain and process the user's identity information (and optionally other report data) from the previously encrypted source data (i.e., decrypting the compliance-device-based encrypted source data using a compliance device private key of the compliance device).

——Secured Private Credential Certificates ——

As noted above, the need for proving credentials continues to grow, both in terms of uses and in terms of verification. In particular, and particularly during COVID-19, knowing who has and who has not been tested and/or vaccinated, which is currently based on simplistic and easily counterfeited paper documentation, allows establishments such as restaurants, entertainment venues, travel ports (e.g., airports, cruise terminals, etc.) to determine who can enter/pass. As also noted above, however, in order to be effective, individuals must be able to prove that they are the actual owner of a paper certificate, and that the paper certificate itself is, in fact, valid. Paper certificates, therefore, suffer many deficiencies, such as counterfeits, lack of identification verification, privacy concerns, getting lost or forgotten, and so on.

The techniques herein, therefore, provide a secured private credential certificate, particularly using verified online communication channels. In particular, based on the zero-knowledge architecture described above, the techniques herein allow for the secure management of user identity (e.g., full name or more, including birthday, driver's license numbers, and other PII) and credential status (e.g., vaccinations, tests, age minimums, and so on) via frictionless communication.

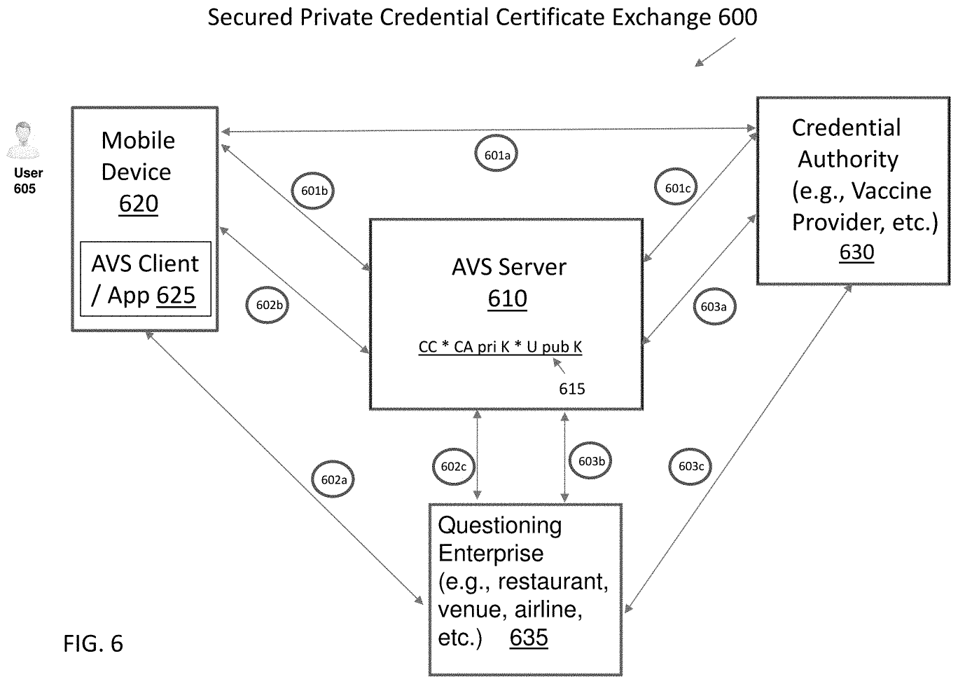

FIG. 6, in particular, shows an environment 600 for a secured private credential certificate exchange, in which a user 605 obtains a credential certificate “CC” (e.g., a “passport”) from credential authority 630 (e.g., a vaccine provider, health provider, testing agency (whether for health, academics, or otherwise), potential employer for an applicant, etc.), and later presents credential certificate from his/her mobile device 620 to a questioning enterprise 635 (e.g., a restaurant, venue, airline, etc.), through illustrative coordination by the AVS server 610.

To produce the credential certificate, a user 605 may first be authenticated (e.g., biometrically) using the AVS client/app 625 and establishes a session 601a with a device at the credential authority (e.g., a health/vaccine provider). Both the AVS App 625 and the credential authority 630 establish a session with the AVS server, 601b and 601c, respectively. In one example implementation, the AVS server 610 issues a unique session ID to the AVS client/app 625. The AVS app presents the mobile device 620 to the credential authority device 630 which in return sends the session ID to the AVS Server, thus securing a common session between the three devices (AVS app 625, credential authority 630, and AVS server 610). The description of the session establishment was provided as a simplified illustration. It should be apparent to those skilled in the art that the establishment of a common session between the AVS App, the AVS/storage server, and the credential authority server can be established in any other order and by having any of the three devices generating and issuing the unique session ID.

Once the user 605 (via AVS client/app 625) is authenticated (attested identity is verified at the mobile device 620) and connected to the credential authority 630 (e.g., a health provider) over connection session 601a, then one or more credentials may be established by the credential authority, such as performing a particular action (e.g., vaccination, testing, screening, etc.) or through confirmation of a previously set credential criteria (e.g., confirming an age, a membership in a group, a demographic, etc.). Attestation to the credential certificate (“CC”) information (e.g., attestation for vaccination or test results) is then encrypted with the credential authority's (CA's) private key “CA PriK”:

Encrypted credential certificate=[CC*CA PriK] Eq. 7a.

The encrypted credential certificate may then be sent in this format to the AVS App 625 on the mobile device 620. As such, the AVS App may then further encrypt the credential certificate using its own public key “U PubK”:

User-encrypted credential certificate=[CC*CA PriK*U PubK] Eq. 7b.

The AVS app 625 then stores the user-encrypted credential certificate 615 on the AVS server 610 (via communication session 601b). Note that in a specific implementation, the ID of the credential authority (e.g., the health provider) is also stored at the AVS server. Also, in one embodiment, the public key of the credential authority (“CA PubK”) may be stored at the AVS server (as described below).

Still with reference to FIG. 6, the user 605 may wish to securely and privately present the user-encrypted credential certificate 615 to what is referred to herein as the “questioning enterprise” (QE) 635 (i.e., a device of the questioning enterprise), such as a restaurant, airline, cruise terminal, etc. Note that the user 605 (the mobile device 620) may be physically co-located with the questioning enterprise (device) 635, and as such communication session 602a may be a local communication, such as a display-to-camera communication (e.g., QR code presenting/reading, in either direction), near field communication protocols, Wi-Fi/wireless communication, manual user code entry (e.g., displaying a code on the questioning enterprise device, and entering the code on the user's mobile device), and so on. This is particularly the case where entry or participation by the user is based on presentation of their credentials. Note that in this embodiment, the questioning enterprise device 635 may consist of another user device (e.g., a guard, bouncer, host/hostess, check-in staff, ticketing agent, etc.), or may be an automated kiosk, a point of sale (POS) system with customer-facing interface, or still other implementation. In another embodiment, the user device 620 may be remotely located from the questioning enterprise 635, and communication session 602a may be over the internet, over cellular/telephone communication channels, etc. This particular embodiment may be in instances where, for example, tickets for an event are being purchased in advance, reservations are being made, items are being purchased online (e.g., based on discount program memberships), and so on.

Assume for the sake of discussion that the user 605 approaches an enterprise which requires certain credentials (e.g., a vaccination) and points the AVS App 625 of the user's mobile device 620 at a co-located kiosk/device of the questioning enterprise (e.g., upon entering a restaurant), hereinafter the “QE device” 630. The QE device conveys to the AVS App 625 the information (e.g., vaccination and/or test result, or otherwise) that is required for entry. The user 605 may then be authenticated against the AVS App (e.g., facial recognition, finger print, etc.), and the AVS App may present to the QE device the identification of the credential authority 630 which issued the appropriate credentials. As such, a common session may be established between each of the AVS App 625, the AVS server 610, and the QE device 635 (602a-c, as shown).

In one example implementation, the AVS App 625 obtains from the QE device 635 its public key “QE PubK” (e.g., over session 602a). According to the techniques herein, the AVS App may then create the appropriate recipient-based rekeying key/conversion key (as described above) by encrypting its private key (“U PriK”) with the QE public key:

QE-based rekeying key=[U PriK*QE PubK] Eq. 8a.

The AVS App 625 may then forwards the QE-based rekeying key to the AVS server 610 over session 602b, and the AVS server uses this key to re-encrypt the stored user's credential certificate 615. Namely:

[CC*CA PriK*U PubK]*[U PriK*QE PubK]=>[CC*CA PriK*(U PubK*U PriK)*QE PubK]=>[CC*CA PriK*QE PubK]=>QE-Based Encrypted Credential Certificate Eq. 8b.

The newly QE-based encrypted credential certificate may then be conveyed to the questioning enterprise using the established session 602c.

The QE device can now use its private key (“QE PriK”) to decrypt the information it received from the AVS server:

[CC*CA PriK*QE PubK]*[QE PriK]=>[CC*CA PriK*QE PubK*QE PriK]=>[CC*CA PriK]=>Encrypted credential certificate(Original) Eq. 8c.

To validate the credential certificate, the questioning enterprise device 635 obtains the public key of the credential authority (“CA PubK”) either directly from the credential authority 630 (whose ID it obtained from the previous session) over communication session 603c (e.g., upon validating that the ID is associated with a valid credential authority), or from the AVS server 610 via communication session 603b. It may also be generally known in advance of the session with the particular user. After the QE device obtains the encrypted credential certificate and obtains the public key of the credential authority, the QE device applies the public key of the credential authority to the encrypted credential certificate obtained from the AVS server:

[CC*CA PriK]*[CA PubK]=>[CC*(CA pPriK*CA PubK)]=>[CC]=>Validated credential certificate Eq. 8d.

In particular, the fact that applying the public key of the credential authority results in a valid credential certificate is an indication that the certificate is valid.

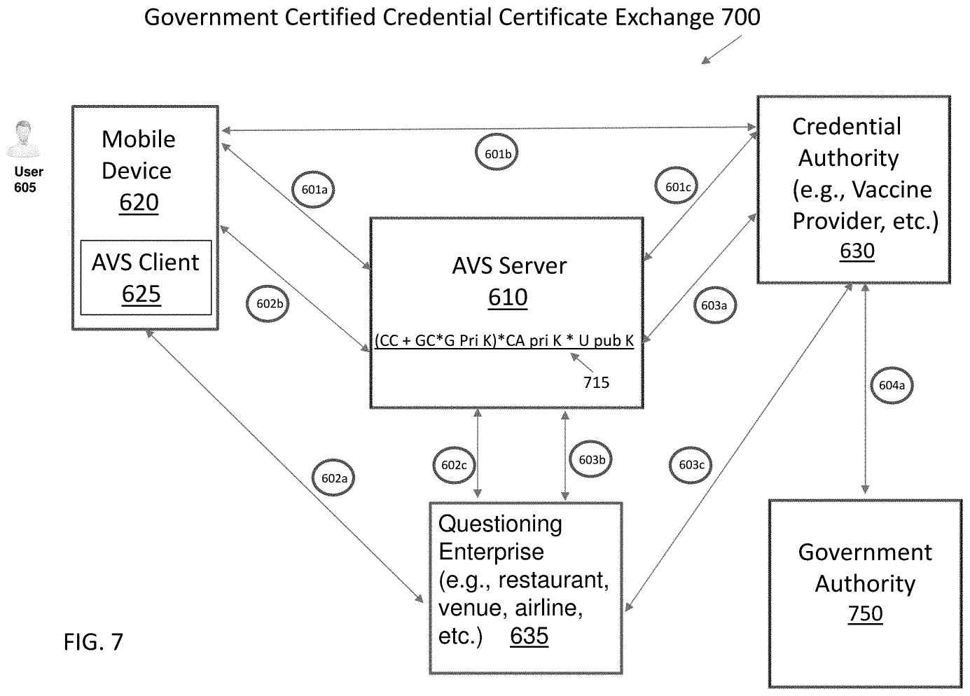

Turning now to exchange 700 of FIG. 7, one specific embodiment herein relates to government certification of the credential certificate herein. That is, as part of the credential certificate production, the credential authority may be issued a certificate from the government authority 750 that certifies that the credential authority is a government authorized credential authority. For example, for healthcare providers (e.g., vaccine sites, testing sites, etc.), the government certificate (“GC”) certifies that the healthcare provider is a government approved credential authority for health-related information (e.g., vaccinations, test results, etc.). The government certificate illustratively includes the name of the credential authority and is signed (encrypted) by the government private key (“G PriK”), thus:

Signed Government Certificate=[GC*G PriK] Eq. 9a.

According to this particular embodiment, as the credential authority issues credential certificates (CC), it attaches to the credential certificates the signed government certificate (GC*G PriK) and then encrypts the combined result with its private key:

Encrypted government signed credential certificate=[(CC+GC*G PriK)*CA PriK] Eq. 9b,

where the “+” operator signifies an attachment or a concatenation of the credential certificate with the encrypted government certificate. The encrypted government signed credential certificate is then sent from the credential authority 630 to the AVS App 625, which further encrypts it with the AVS App's private key:

User-encrypted government signed credential certificate=[(CC+GC*G PriK)*CA PriK*U PubK] Eq. 9c.

This user-encrypted government signed credential certificate (715) is then sent to the AVS server 610 for storage.

Validating the government certified credential certificate is then similar to the flow described above. When presenting the credential certificate to the QE device 635, the AVS App 625 encrypts its private key with the QE public key [U PriK*QE PubK] to create the QE-based rekeying key, and forwards it to the AVS server. The AVS server uses this QE-based rekeying key to re-encrypt the stored user-encrypted government signed credential certificate 715:

[(CC+GC*G PriK)*CA PriK*U PubK]*[U PriK*QE PubK]=>[(CC+GC*G PriK)*CA PriK*(U PubK*U PriK)*QE PubK]=>[(CC+GC*G PriK)*CA PriK*QE PubK]=>QE-Based Encrypted Gvt. Signed Cred. Cert. Eq. 9d.

The newly encrypted QE-based encrypted government signed credential certificate from Eq. 9d above is then conveyed to the QE device 635 using the established session, such that the questioning enterprise can use its private key to decrypt the information it received from the AVS server:

[(CC+GC*G PriK)*CA PriK*QE PubK]*[QE PriK]=>[(CC+GC*G PriK)*CA PriK*(QE PubK*QE PriK)]=>[(CC+GC*G PriK)*CA PriK]=>Encrypted Gov. Signed Cred. Cert.(Original) Eq. 9e.

Using the public key of the credential authority 630 (either directly from the credential authority or from the AVS server), the QE device may then apply that public key to the original encrypted government signed credential certificate:

[(CC+GC*G PriK)*CA PriK]*[CA PubK]=>[(CC+GC*G PriK)*CA PriK*CA PubK]=>[(CC+GC*G PriK)]=>Decrypted Gov. Signed Cred. Cert.(Original) Eq. 9f.

Now that the original credential certificate (CC) is decrypted, in order to ensure that the credential certificate was issued by a government certified entity (i.e., that the credential authority 630 is certified by the government authority 750), the questioning enterprise 635 takes the “seal” (GC*G PriK) attached to CC and verifies it using the public key of the government (“G PubK”), resulting in:

[GC*G PriK]*[G PubK]=>[GC*(G PriK*G PubK)]=>GC Eq. 9g.

If the result of this authentication step in Eq. 9g yields the official government certificate GC, then the credential authority's credential certificate (CC) is both valid and government certified.

Advantageously, the techniques described herein thus provide for a secured private credential certificate. In particular, the techniques herein provide a credential certificate (e.g., vaccination verification/passport, test result, etc.) that is verified to be signed by the issuer (e.g., a health provider), ensuring that there are no fake credentials in circulation, and credentials cannot be passed to another person, ensuring their validity when presented. In addition, while all interactions may be specifically governed by authentication of the user (e.g., biometrics), the techniques above ensure that there is complete privacy: the identity of the user is not disclosed to the credential issuer (e.g., health provider) nor to the establishment where the credential is presented (e.g., a restaurant, airline, etc.). Moreover, the techniques herein are convenient because users do not need to worry about carrying the most updated information nor multiple credential certificates from different health providers, and are frictionless, in that the automated interaction between each of the endpoints (e.g., users, servers, credentialing authorities, etc.) do not require human intervention (beyond initiating the communication, taking a picture of QR code, keying in a session validation ID, etc.). Lastly, the techniques herein may afford various cost savings, as establishments need not employ additional guards/gatekeepers at their entrance (e.g., using kiosks), entities with longer lines (e.g., airports, concert venues, sporting events) have faster processing times, and so on.

Illustratively, the techniques described herein may be performed by hardware, software, and/or firmware, such as in accordance with the “credential certificate” process 248, which may include computer executable instructions executed by a processor 220 (of a particular correspondingly operative computing device 200) to perform functions relating to the techniques described herein, e.g., in conjunction with other devices which may have a correspondingly configured processes depending upon the functionality of the device, as described below (e.g., a user device, a verifying device, a storage server, an attestation service, and so on).

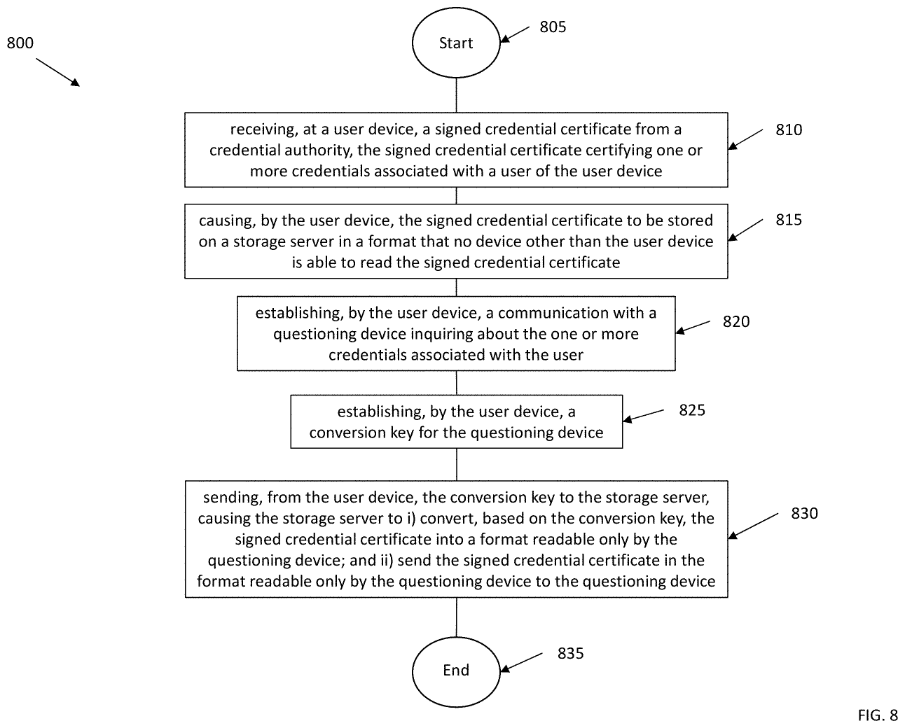

FIG. 8 illustrates an example simplified procedure for managing a secured private credential certificate in accordance with one or more embodiments described herein, particularly from the perspective of a user device presenting their user's certificate. For example, a non-generic, specifically configured device (e.g., device 200, such as a mobile device/user device 620, etc.) may perform procedure 800 by executing stored instructions (e.g., process 248). The procedure 800 may start at step 805, and continues to step 810, where, as described in greater detail above, a user device 620 receives a signed credential certificate from a credential authority 630, the signed credential certificate certifying one or more credentials associated with a user of the user device. In step 815 the user device causes the signed credential certificate to be stored on a storage server 610 in a format that no device other than the user device is able to read the signed credential certificate.

Upon establishing a communication with a questioning device 635 inquiring about the one or more credentials associated with the user in step 820, the user device then establishes a conversion key for the questioning device in step 825. In step 830, the user device then sends the conversion key to the storage server, causing the storage server to i) convert, based on the conversion key, the signed credential certificate into a format readable only by the questioning device; and ii) send the signed credential certificate in the format readable only by the questioning device to the questioning device.

The simplified procedure 800 then ends in step 835.

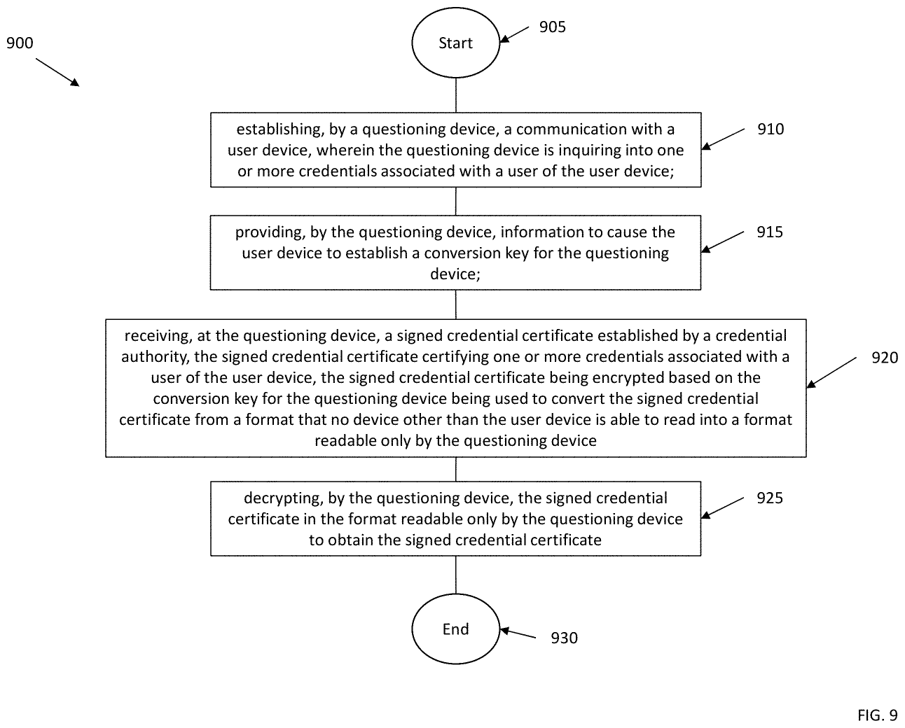

FIG. 9 illustrates another example simplified procedure for managing a secured private credential certificate in accordance with one or more embodiments described herein, particularly from the perspective of an entity questioning the certificate. For example, a non-generic, specifically configured device (e.g., device 200, such as a questioning enterprise/device 635, etc.) may perform procedure 900 by executing stored instructions (e.g., process 248). The procedure 900 may start at step 905, and continues to step 910, where, as described in greater detail above, a questioning device 635 establishes a communication with a user device 620, wherein the questioning device is inquiring into one or more credentials associated with a user of the user device. Accordingly, in step 915, the questioning device provides information to cause the user device to establish a conversion key for the questioning device.

In response, in step 920, the questioning device receives a signed credential certificate established by a credential authority, the signed credential certificate certifying one or more credentials associated with a user of the user device, the signed credential certificate being encrypted based on the conversion key for the questioning device being used to convert the signed credential certificate from a format that no device other than the user device is able to read into a format readable only by the questioning device. As such, in step 925, the questioning device decrypts the signed credential certificate in the format readable only by the questioning device to obtain the signed credential certificate.

The simplified procedure 900 illustratively ends in step 930.

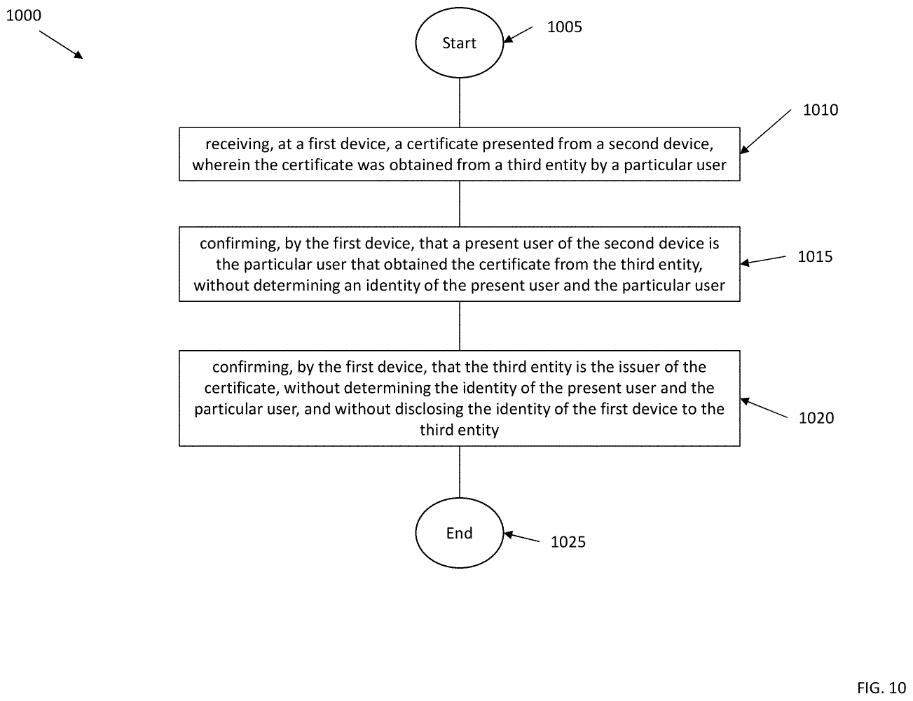

In addition, as another perspective of the techniques herein, FIG. 10 illustrates another example simplified procedure for managing a secured private credential certificate in accordance with one or more embodiments described herein. In this example, a “first device” (e.g., entity/enterprise 635) is inquiring about the certificate of a user associated with a “second device” (e.g., user/mobile device 620), which was issued by a “third entity” (e.g., the credential authority 630). For instance, a non-generic, specifically configured device (e.g., device 200, such as the enterprise device 635) may perform procedure 1000 by executing stored instructions (e.g., process 248). The procedure 1000 may start at step 1005, and continues to step 1010, where, as described in greater detail above, the first device receives a certificate presented from a second device, wherein the certificate was obtained from a third entity by a particular user. Note that as described above, in one embodiment the certificate is actually received from a storage server (e.g., AVS server 630), and not directly from the second device. As such, “receiving a certificate*presented*from a second device” is not limited to receiving the certificate*from*the second device, but merely that a second device is initiating presentation of the certificate, as described above. That is, presenting the certificate from the second device may, in fact, be sent via (or from) a storage server that stores the certificate in a format unreadable to the storage server (and in a format unreadable to the first device until the second device provides a mechanism to convert the certificate into a format that is readable to the first device prior to presenting the certificate to the first device).

In step 1015, the first device may then confirm that a present user of the second device (i.e., the user actually at the second device) is the particular user that obtained the certificate from the third entity, without determining an identity of the present user and the particular user. Then, in step 1020, the first device may further confirm that the third entity is the issuer of the certificate, without determining the identity of the present user and the particular user, and without disclosing the identity of the first device to the third entity. The illustrative procedure 1000 then ends in step 1025.

It should be noted that the steps shown and described in the procedures above are merely examples for illustration, and certain other steps may be included or excluded as desired. For instance, other steps may also be included generally within procedures above as described herein. For example, such steps (whether additional steps or furtherance of steps already specifically illustrated above) may include such things as: confirming that the certificate contains a proof that the third entity/credential authority is certified by a fourth party (e.g., the government) to issue the certificate; encrypting the signed credential certificate with a user encryption key of the user device into the format that no device other than the user device is able to read; decrypting a signed credential certificate in a format readable only by the questioning device using a private key of the questioning device to obtain the signed credential certificate; validating the signed credential certificate using a decryption key of the credential authority; authenticating the user at the user device, and so on, as detailed further herein. Further, while a particular order of the steps is shown, this ordering is merely illustrative, and any suitable arrangement of the steps may be utilized without departing from the scope of the embodiments herein. Moreover, while procedures may be described separately, certain steps from each procedure may be incorporated into each other procedure, and the procedures are not meant to be mutually exclusive.

In closing, an illustrative method according to one or more embodiments of the present disclosure may comprise: receiving, at a user device, a signed credential certificate from a credential authority, the signed credential certificate certifying one or more credentials associated with a user of the user device; causing, by the user device, the signed credential certificate to be stored on a storage server in a format that no device other than the user device is able to read the signed credential certificate; establishing, by the user device, a communication with a questioning device inquiring about the one or more credentials associated with the user; establishing, by the user device, a conversion key for the questioning device; and sending, from the user device, the conversion key to the storage server, causing the storage server to i) convert, based on the conversion key, the signed credential certificate into a format readable only by the questioning device; and ii) send the signed credential certificate in the format readable only by the questioning device to the questioning device.

In one embodiment, the method further comprises: encrypting, by the user device, the signed credential certificate with a user encryption key of the user device into the format that no device other than the user device is able to read, hereinafter a user-encrypted signed credential certificate, wherein the conversion key comprises an encrypting combination of a user decryption key of the user device and a public key of the questioning device, and wherein the conversion key causes the storage server to convert the signed credential certificate into a format readable only by the questioning device by re-encrypting the user-encrypted signed credential certificate with the conversion key, wherein the questioning device is caused to decrypt the signed credential certificate in the format readable only by the questioning device using a private key of the questioning device to obtain the signed credential certificate.

In one embodiment, the signed credential certificate comprises the one or more credentials encrypted with an encryption key of the credential authority, and wherein the questioning device validates the signed credential certificate using a decryption key of the credential authority.

In one embodiment, the one or more credentials associated with the user are selected from a group consisting of: health information; vaccination information; and health testing results; application results; and reports.

In one embodiment, the method further comprises: authenticating the user at the user device prior to receiving the signed credential certificate from the credential authority.

In one embodiment, the method further comprises: authenticating the user at the user device during the communication with the questioning device inquiring about the one or more credentials associated with the user.

In one embodiment, the signed credential certificate comprises a government authorization for the credential authority. In one embodiment, the questioning device validates the government authorization using a decryption key of the government authority after reading the signed credential certificate.

In one embodiment, establishing the communication with the questioning device comprises a co-located local communication. In one embodiment, the local communication is selected from a group consisting of: display to camera communication; printed images to camera communication; near field communication; Wi-Fi; and manual entry of displayed codes.

In one embodiment, establishing the communication with the questioning device comprises a remote communication.

In one embodiment, the questioning device is associated with an enterprise selected from a group consisting of: a building; a structure; a vehicle; a ticket agency; a restaurant; a bar; an entertainment venue; a sport venue; a travel port; a political border entry; a school; a livery transportation vehicle; and a store.

Also, an illustrative apparatus according to one or more embodiments of the present disclosure may comprise: one or more network interfaces to communicate with a computer network; a processor coupled to the network interfaces and adapted to execute one or more processes; and a memory configured to store a process executable by the processor, the process when executed on a user device operable to perform a method comprising: receiving a signed credential certificate from a credential authority, the signed credential certificate certifying one or more credentials associated with a user of the user device; causing the signed credential certificate to be stored on a storage server in a format that no device other than the user device is able to read the signed credential certificate; establishing a communication with a questioning device inquiring about the one or more credentials associated with the user; establishing a conversion key for the questioning device; and sending the conversion key to the storage server, causing the storage server to i) convert, based on the conversion key, the signed credential certificate into a format readable only by the questioning device; and ii) send the signed credential certificate in the format readable only by the questioning device to the questioning device.

Furthermore, an illustrative tangible, non-transitory, computer-readable medium according to one or more embodiments of the present disclosure may store program instructions that cause a computer as a user device to execute a process comprising: receiving a signed credential certificate from a credential authority, the signed credential certificate certifying one or more credentials associated with a user of the user device; causing the signed credential certificate to be stored on a storage server in a format that no device other than the user device is able to read the signed credential certificate; establishing a communication with a questioning device inquiring about the one or more credentials associated with the user; establishing a conversion key for the questioning device; and sending the conversion key to the storage server, causing the storage server to i) convert, based on the conversion key, the signed credential certificate into a format readable only by the questioning device; and ii) send the signed credential certificate in the format readable only by the questioning device to the questioning device.

In addition, another illustrative method according to one or more embodiments of the present disclosure may comprise: establishing, by a questioning device, a communication with a user device, wherein the questioning device is inquiring into one or more credentials associated with a user of the user device; providing, by the questioning device, information to cause the user device to establish a conversion key for the questioning device; receiving, at the questioning device, a signed credential certificate established by a credential authority, the signed credential certificate certifying one or more credentials associated with a user of the user device, the signed credential certificate being encrypted based on the conversion key for the questioning device being used to convert the signed credential certificate from a format that no device other than the user device is able to read into a format readable only by the questioning device; and decrypting, by the questioning device, the signed credential certificate in the format readable only by the questioning device to obtain the signed credential certificate.

In one embodiment, the signed credential certificate is stored on a storage server and is encrypted by the user device with a user encryption key of the user device into the format that no device other than the user device is able to read, hereinafter a user-encrypted signed credential certificate, wherein the conversion key comprises an encrypting combination of a user decryption key of the user device and a public key of the questioning device, and wherein the conversion key causes the storage server to convert the signed credential certificate into a format readable only by the questioning device by re-encrypting the user-encrypted signed credential certificate with the conversion key, the method further comprising: decrypting, by the questioning device, the signed credential certificate in the format readable only by the questioning device using a private key of the questioning device to obtain the signed credential certificate.

In one embodiment, the signed credential certificate comprises the one or more credentials encrypted with an encryption key of the credential authority, the method further comprising: validating, by the questioning device, the signed credential certificate using a decryption key of the credential authority.

In one embodiment, the one or more credentials associated with the user are selected from a group consisting of: health information; vaccination information; testing results; application results; and reports.

In one embodiment, in response to inquiring about the one or more credentials associated with the user, the method further comprises: authenticating the user at the user device during the communication with the user device.

In one embodiment, the signed credential certificate comprises a government authorization for the credential authority. In one embodiment, the method further comprises: validating the government authorization using a decryption key of the government authority after reading the signed credential certificate.

In one embodiment, establishing the communication with the user device comprises a co-located local communication. In one embodiment, the local communication is selected from a group consisting of: display to camera communication; printed images to camera communication; near field communication; Wi-Fi; and manual entry of displayed codes.

In one embodiment, establishing the communication with the user device comprises a remote communication.

Also, an illustrative apparatus according to one or more embodiments of the present disclosure may comprise: one or more network interfaces to communicate with a computer network; a processor coupled to the network interfaces and adapted to execute one or more processes; and a memory configured to store a process executable by the processor, the process when executed on a questioning device operable to perform a method comprising: establishing a communication with a user device, wherein the questioning device is inquiring into one or more credentials associated with a user of the user device; providing information to cause the user device to establish a conversion key for the questioning device; receiving a signed credential certificate established by a credential authority, the signed credential certificate certifying one or more credentials associated with a user of the user device, the signed credential certificate being encrypted based on the conversion key for the questioning device being used to convert the signed credential certificate from a format that no device other than the user device is able to read into a format readable only by the questioning device; and decrypting the signed credential certificate in the format readable only by the questioning device to obtain the signed credential certificate.

Furthermore, an illustrative tangible, non-transitory, computer-readable medium according to one or more embodiments of the present disclosure may store program instructions that cause a computer as a questioning device to execute a process comprising: establishing a communication with a user device, wherein the questioning device is inquiring into one or more credentials associated with a user of the user device; providing information to cause the user device to establish a conversion key for the questioning device; receiving a signed credential certificate established by a credential authority, the signed credential certificate certifying one or more credentials associated with a user of the user device, the signed credential certificate being encrypted based on the conversion key for the questioning device being used to convert the signed credential certificate from a format that no device other than the user device is able to read into a format readable only by the questioning device; and decrypting the signed credential certificate in the format readable only by the questioning device to obtain the signed credential certificate.

Still further, another illustrative method according to one or more embodiments of the present disclosure may comprise: receiving, at a first device, a certificate presented from a second device, wherein the certificate was obtained from a third entity by a particular user; confirming, by the first device, that a present user of the second device is the particular user that obtained the certificate from the third entity, without determining an identity of the present user and the particular user; and confirming, by the first device, that the third entity is an issuer of the certificate, without determining the identity of the present user and the particular user, and without disclosing the identity of the first device to the third entity.

In one embodiment, the method further comprises: confirming, by the first device, that the certificate contains a proof that the third entity is certified by a fourth party to issue the certificate.

In one embodiment, the method further comprises: providing information, prior to receiving the certificate, to cause the second device to establish a conversion key for the first device, wherein the received certificate is encrypted based on the conversion key for the first device being used to convert the certificate from a format that no device other than the second device is able to read into a format readable only by the first device; wherein confirming that the present user of the second device is the particular user that obtained the certificate from the third entity and confirming that the third entity is the issuer of the certificate, are based on decrypting the certificate in the format readable only by the first device to obtain a signed certificate issued by the third entity for the particular user, without determining the identity of the present user and the particular user. In one embodiment, the signed certificate comprises one or more credentials associated with the particular user and is encrypted with an encryption key of the third entity, and wherein confirming that the third entity is the issuer of the certificate comprises: validating the signed certificate using a decryption key of the third entity.

In one embodiment, the certificate is associated with one or more credentials selected from a group consisting of: health information; vaccination information; testing results; application results; and reports.

In one embodiment, the method further comprises: communicating with the second device over a local communication mechanism. In one embodiment, the local communication mechanism is selected from a group consisting of: display to camera communication; printed images to camera communication; near field communication; Wi-Fi; and manual entry of displayed codes.

In one embodiment, the method further comprises: communicating with the second device over a remote communication network.

In one embodiment, the certificate is presented from the second device via a storage server that stores the certificate in a format unreadable to the storage server. In one embodiment, the storage server stores the certificate in a format unreadable to the first device until the second device provides a mechanism to convert the certificate into a format that is readable to the first device prior to presenting the certificate to the first device.

Also, an illustrative apparatus according to one or more embodiments of the present disclosure may comprise: one or more network interfaces to communicate with a computer network; a processor coupled to the network interfaces and adapted to execute one or more processes; and a memory configured to store a process executable by the processor, the process when executed on a first device operable to perform a method comprising: receiving a certificate presented from a second device, wherein the certificate was obtained from a third entity by a particular user; confirming that a present user of the second device is the particular user that obtained the certificate from the third entity, without determining an identity of the present user and the particular user; and confirming that the third entity is an issuer of the certificate, without determining the identity of the present user and the particular user, and without disclosing the identity of the first device to the third entity.

Furthermore, an illustrative tangible, non-transitory, computer-readable medium according to one or more embodiments of the present disclosure may store program instructions that cause a computer as a first device to execute a process comprising: receiving a certificate presented from a second device, wherein the certificate was obtained from a third entity by a particular user; confirming that a present user of the second device is the particular user that obtained the certificate from the third entity, without determining an identity of the present user and the particular user; and confirming that the third entity is an issuer of the certificate, without determining the identity of the present user and the particular user, and without disclosing the identity of the first device to the third entity.

While there have been shown and described illustrative embodiments, it is to be understood that various other adaptations and modifications may be made within the scope of the embodiments herein. For example, though the disclosure was often described with respect to vaccination examples, those skilled in the art should understand that this was done only for illustrative purpose and without limitations, and the techniques herein may be used for any secured private credential certificates. For example, other credentialed information about a user that may need to be verified, without having to share personally identifying information (PII) of the user, may include such things as age (e.g., over 21 years old), being a student at a particular school, being an employee of a particular company, being an active or veteran member of the military, having VIP membership status, and so on. Furthermore, while the embodiments may have been demonstrated with respect to certain communication environments, physical environments, or device form factors, other configurations may be conceived by those skilled in the art that would remain within the contemplated subject matter of the description above.

The foregoing description has been directed to specific embodiments. It will be apparent, however, that other variations and modifications may be made to the described embodiments, with the attainment of some or all of their advantages. For instance, it is expressly contemplated that certain components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true intent and scope of the embodiments herein.

What is claimed is:

1. A method, comprising:
receiving, at a user device, a signed credential certificate from a credential authority, the signed credential certificate certifying one or more credentials associated with a user of the user device;
causing, by the user device, the signed credential certificate to be stored on a storage server in a format that no device other than the user device is able to read the signed credential certificate;
establishing, by the user device, a communication with a questioning device inquiring about the one or more credentials associated with the user;
establishing, by the user device, a conversion key for the questioning device; and
sending, from the user device, the conversion key to the storage server, causing the storage server to i) convert, based on the conversion key, the signed credential certificate into a format readable only by the questioning device; and ii) send the signed credential certificate in the format readable only by the questioning device to the questioning device.

2. The method as in claim 1, further comprising:
encrypting, by the user device, the signed credential certificate with a user encryption key of the user device into the format that no device other than the user device is able to read, hereinafter a user-encrypted signed credential certificate,
wherein the conversion key comprises an encrypting combination of a user decryption key of the user device and a public key of the questioning device, and wherein the conversion key causes the storage server to convert the signed credential certificate into a format readable only by the questioning device by re-encrypting the user-encrypted signed credential certificate with the conversion key,
wherein the questioning device is caused to decrypt the signed credential certificate in the format readable only by the questioning device using a private key of the questioning device to obtain the signed credential certificate.

3. The method as in claim 1, wherein the signed credential certificate comprises the one or more credentials encrypted with an encryption key of the credential authority, and wherein the questioning device validates the signed credential certificate using a decryption key of the credential authority.

4. The method as in claim 1, wherein the one or more credentials associated with the user are selected from a group consisting of: health information; vaccination information; testing results; application results; and reports.

5. The method as in claim 1, further comprising:
authenticating the user at the user device prior to receiving the signed credential certificate from the credential authority.

6. The method as in claim 1, further comprising:
authenticating the user at the user device during the communication with the questioning device inquiring about the one or more credentials associated with the user.

7. The method as in claim 1, wherein the signed credential certificate comprises a government authorization for the credential authority.

8. The method as in claim 7, wherein the questioning device validates the government authorization using a decryption key of a government authority after reading the signed credential certificate.

9. The method as in claim 1, wherein establishing the communication with the questioning device comprises a co-located local communication.

10. The method as in claim 9, wherein the local communication is selected from a group consisting of: display to camera communication; printed images to camera communication; near field communication; Wi-Fi; and manual entry of displayed codes.

11. The method as in claim 1, wherein establishing the communication with the questioning device comprises a remote communication.

12. The method as in claim 1, wherein the questioning device is associated with an enterprise selected from a group consisting of: a building; a structure; a vehicle; a ticket agency; a restaurant; a bar; an entertainment venue; a sport venue; a travel port; a political border entry; a school; a livery transportation vehicle; and a store.

13. A method, comprising:
establishing, by a questioning device, a communication with a user device, wherein the questioning device is inquiring into one or more credentials associated with a user of the user device;
providing, by the questioning device, information to cause the user device to establish a conversion key for the questioning device;
receiving, at the questioning device, a signed credential certificate established by a credential authority, the signed credential certificate certifying one or more credentials associated with a user of the user device, the signed credential certificate being encrypted based on the conversion key for the questioning device being used to convert the signed credential certificate from a format that no device other than the user device is able to read into a format readable only by the questioning device; and
decrypting, by the questioning device, the signed credential certificate in the format readable only by the questioning device to obtain the signed credential certificate.

14. The method as in claim 13, wherein the signed credential certificate is stored on a storage server and is encrypted by the user device with a user encryption key of the user device into the format that no device other than the user device is able to read, hereinafter a user-encrypted signed credential certificate, wherein the conversion key comprises an encrypting combination of a user decryption key of the user device and a public key of the questioning device, and wherein the conversion key causes the storage server to convert the signed credential certificate into a format readable only by the questioning device by re-encrypting the user-encrypted signed credential certificate with the conversion key, the method further comprising:
decrypting, by the questioning device, the signed credential certificate in the format readable only by the questioning device using a private key of the questioning device to obtain the signed credential certificate.

15. The method as in claim 13, wherein the signed credential certificate comprises the one or more credentials encrypted with an encryption key of the credential authority, the method further comprising:
validating, by the questioning device, the signed credential certificate using a decryption key of the credential authority.

16. The method as in claim 13, wherein the one or more credentials associated with the user are selected from a group consisting of: health information; vaccination information; testing results; application results; and reports.

17. The method as in claim 13, wherein, in response to inquiring about the one or more credentials associated with the user, the method further comprises:
authenticating the user at the user device during the communication with the user device.

18. The method as in claim 13, wherein the signed credential certificate comprises a government authorization for the credential authority.

19. The method as in claim 18, further comprising:
validating the government authorization using a decryption key of a government authority after reading the signed credential certificate.

20. The method as in claim 13, wherein establishing the communication with the user device comprises a co-located local communication.

21. The method as in claim 20, wherein the local communication is selected from a group consisting of: display to camera communication; printed images to camera communication; near field communication; Wi-Fi; and manual entry of displayed codes.

22. The method as in claim 13, wherein establishing the communication with the user device comprises a remote communication.

23. A method, comprising:
receiving, at a first device, a certificate presented from a second device, wherein the certificate was obtained from a third entity by a particular user;
confirming, by the first device, that a present user of the second device is the particular user that obtained the certificate from the third entity, without determining an identity of the present user and the particular user; and
confirming, by the first device, that the third entity is an issuer of the certificate, without determining the identity of the present user and the particular user, and without disclosing the identity of the first device to the third entity.

24. The method as in claim 23, further comprising:
confirming, by the first device, that the certificate contains a proof that the third entity is certified by a fourth party to issue the certificate.

25. The method as in claim 23, further comprising:
providing information, prior to receiving the certificate, to cause the second device to establish a conversion key for the first device, wherein the received certificate is encrypted based on the conversion key for the first device being used to convert the certificate from a format that no device other than the second device is able to read into a format readable only by the first device;
wherein confirming that the present user of the second device is the particular user that obtained the certificate from the third entity and confirming that the third entity is the issuer of the certificate, are based on decrypting the certificate in the format readable only by the first device to obtain a signed certificate issued by the third entity for the particular user, without determining the identity of the present user and the particular user.

26. The method as in claim 25, wherein the signed certificate comprises one or more credentials associated with the particular user and is encrypted with an encryption key of the third entity, and wherein confirming that the third entity is the issuer of the certificate comprises:
validating the signed certificate using a decryption key of the third entity.

27. The method as in claim 23, wherein the certificate is associated with one or more credentials selected from a group consisting of: health information; vaccination information; testing results; application results; and reports.

28. The method as in claim 23, further comprising:
communicating with the second device over a local communication mechanism.

29. The method as in claim 28, wherein the local communication mechanism is selected from a group consisting of: display to camera communication; printed images to camera communication; near field communication; Wi-Fi; and manual entry of displayed codes.

30. The method as in claim 23, further comprising:
communicating with the second device over a remote communication network.

31. The method as in claim 23, wherein the certificate is presented from the second device via a storage server that stores the certificate in a format unreadable to the storage server.

32. The method as in claim 31, wherein the storage server stores the certificate in a format unreadable to the first device until the second device provides a mechanism to convert the certificate into a format that is readable to the first device prior to presenting the certificate to the first device.

33. A tangible, non-transitory, computer-readable medium storing program instructions that cause a computer as a user device to execute a process comprising:
receiving a signed credential certificate from a credential authority, the signed credential certificate certifying one or more credentials associated with a user of the user device;
causing the signed credential certificate to be stored on a storage server in a format that no device other than the user device is able to read the signed credential certificate;
establishing a communication with a questioning device inquiring about the one or more credentials associated with the user;
establishing a conversion key for the questioning device; and
sending the conversion key to the storage server, causing the storage server to i) convert, based on the conversion key, the signed credential certificate into a format readable only by the questioning device; and ii) send the signed credential certificate in the format readable only by the questioning device to the questioning device.

34. A tangible, non-transitory, computer-readable medium storing program instructions that cause a computer as a questioning device to execute a process comprising:
establishing a communication with a user device, wherein the questioning device is inquiring into one or more credentials associated with a user of the user device;
providing information to cause the user device to establish a conversion key for the questioning device;
receiving a signed credential certificate established by a credential authority, the signed credential certificate certifying one or more credentials associated with a user of the user device, the signed credential certificate being encrypted based on the conversion key for the questioning device being used to convert the signed credential certificate from a format that no device other than the user device is able to read into a format readable only by the questioning device; and
decrypting the signed credential certificate in the format readable only by the questioning device to obtain the signed credential certificate.

35. A tangible, non-transitory, computer-readable medium storing program instructions that cause a computer as a first device to execute a process comprising:
receiving a certificate presented from a second device, wherein the certificate was obtained from a third entity by a particular user;
confirming that a present user of the second device is the particular user that obtained the certificate from the third entity, without determining an identity of the present user and the particular user; and
confirming that the third entity is an issuer of the certificate, without determining the identity of the present user and the particular user, and without disclosing the identity of the first device to the third entity.
